(19) United States
(12) Patent Application Publication
(10) Pub. No.: US 2026/0305617 A1
(43) Pub. Date: Oct. 8, 2026

(54) AGRICULTURAL COMPOSITION AND AGRICULTURAL AQUEOUS DISPERSION

(71) Applicant: FUSO CHEMICAL CO., LTD., Osaka-shi, Osaka (JP)

(72) Inventors: Kohei Shimizu, Osaka-shi, Osaka (JP); Shun Manabe, Osaka-shi, Osaka (JP); Yuriko Kawasaki, Osaka-shi, Osaka (JP); Hiroshi Okura, Osaka-shi, Osaka (JP)

(73) Assignee: FUSO CHEMICAL CO., LTD., Osaka-shi, Osaka (JP)

(21) Appl. No.: 19/475,980

(22) PCT Filed: Apr. 9, 2024
(86) PCT No.: PCT/JP2024/014376

§ 371 Date: Oct. 16, 2025

(30) Foreign Application Priority Data
Apr. 19, 2023 (JP) 2023-068687

(51) Int. Cl. A01N 63/50; A01N 25/04; A01N 25/08; A01P 21/00

(52) U.S. Cl. CPC A01N 63/50; A01N 25/04; A01N 25/08; A01P 21/00

(57) ABSTRACT

An agricultural composition that can control the supply of the biostimulants to plants in response to the state of the high temperature stress or the state of the low temperature stress is provided. The agricultural composition includes a temperature-responsive substrate that starts to melt or decompose at a predetermined temperature; and a biostimulant that alleviates a non-biological stress of plants or promotes plant growth.

### TECHNICAL FIELD

The present invention relates to an agricultural composition and an agricultural aqueous dispersion used to improve yield, quality, and the like in agriculture.

### BACKGROUND ART

In agriculture, fertilizers and pesticides have long been used to improve yield, quality, and the like. The fertilizers and the pesticides are usually used for each different purpose. The fertilizers mainly including nitrogen, phosphate, potassium, and the like are used, for example, for the purpose of providing nutrients necessary for the healthy growth of crops (including trees and agricultural and forestry products; hereinafter referred to as “crops and the like”). The pesticides including bactericides, insecticides, and other chemicals are used for direct prevention of bacteria, nematodes, mites, insects, mice, other animals and plants, or viruses (pests) for the purpose of preventing them that damage the crops and the like.

The fertilizers and the pesticides are classified in detail depending on expected effects, and thus the types of the fertilizers and the pesticides are required to be changed each time for each desired effect.

Therefore, in recent years, biostimulants have been attracting attention around the world, particularly in Europe, as new agricultural materials to replace the fertilizers and the pesticides. The biostimulants are various substances and microorganisms that provide better physiological conditions to plants and soils. Biostimulants are characterized by providing positive effects on plant health, stress tolerance, yield and quality, and post-harvest conditions and storage by utilizing the natural forces inherent in plants and the surrounding environment thereof.

A high temperature stress among environmental stresses is caused by rise in environmental temperature, and thus it is important that the biostimulants are supplied before the environmental temperature rises. However, it is difficult to accurately predict weather, the biostimulants are used, for example, once a week or once every two weeks.

Depending on the weather conditions, however, the supplied biostimulants are wasted in the case where a state in which the high temperature stress is not applied continues, contrary to the prediction. Therefore, the supply of the biostimulants is required to be controlled.

As a method for controlling the supply of active components such as the pesticides and the fertilizers, for example, Patent Literature 1 has disclosed compositions for slow-release/sustained-release/controlled-release of the active components. In addition, Patent Literature 2 has disclosed a controlled-release biodegradable composition that releases the active components into soils at a controlled speed. In addition, Patent Literature 3 has disclosed a biodegradable coating composition having a controlled release speed.

In addition, Patent Literature 4 has disclosed coated pesticides or coated fertilizers having a small temperature dependence of the elution speed of the active components.

In addition, Patent Literature 5 has disclosed compositions that release the active components at a certain time after application, but do not release the active components for a certain period of time.

### CITATION LIST

### Patent Literature

Patent Literature 1: Japanese Patent Publication (Translation of PCT Application) No. 2019-523275
Patent Literature 2: Japanese Patent No. 2995423
Patent Literature 3: Japanese Patent Publication (Translation of PCT Application) No. 2021-501246
Patent Literature 4: International Patent Publication No. WO 2020/032224 Patent Literature S: Japanese Patent Publication (Translation of PCT Application) No. 2019-515928

### SUMMARY OF INVENTION

### Technical Problem

However, the compositions disclosed in Patent Literatures 1 to 3 slowly release active components, so that the compositions constantly and continuously supply the active components. Therefore, these compositions do not start to supply the active components when weather causes a state where the high temperature stress is applied. In other words, the compositions disclosed in Patent Literatures 1 to 3 do not allow the active components to be supplied in response to the state of the high temperature stress.

In addition, the products disclosed in Patent Literature 4 have a small temperature dependence of the elution speed of the active components, and thus the active components cannot be supplied in response to the state of the high-temperature stress state.

In addition, the products disclosed in Patent Literature S control the supply of the active components by time, and thus the supply of the active components in response to the state of the high temperature stress cannot be achieved.

In addition, in the case where plants are grown in a low-temperature environment, an excessively low environment temperature due to weather may cause low-temperature stress on the plants. In the case where the low temperature stress is applied, it is important to supply the biostimulants before the environment temperature becomes low. However, similarly to the case of the high temperature stress, it is difficult to predict the weather accurately. Therefore, a use method in which the biostimulant is supplied is performed, for example, once a week or once every two weeks. Depending on the weather conditions, in the case where a state in which the low temperature stress is not applied continues contrary to the prediction, the supplied biostimulant becomes wasted. Consequently, the control of the supply of the biostimulant is required.

Therefore, an object of the present invention is to provide an agricultural composition that can control the supply of the biostimulants to plants in response to the state of the high temperature stress or the state of the low temperature stress.

### Solution to Problem

The above problem is solved by the present invention described below.

That is, the present invention (1) provides an agricultural composition comprising:
a temperature-responsive substrate that starts to melt or decompose at a predetermined temperature; and
a biostimulant that alleviates a non-biological stress of plants or promotes plant growth.

The present invention (2) provides the agricultural composition according to (1), wherein
the temperature-responsive substrate is a material that does not melt or decompose at a temperature lower than the predetermined temperature and starts to melt or decompose when temperature rises to reach the predetermined temperature, and
a melting start temperature or a decomposition start temperature of the temperature-responsive substrate is 30° C. to 60° C.

The present invention (3) provides the agricultural composition according to (1), wherein
the temperature-responsive substrate is a material that does not melt or decompose at a temperature higher than the predetermined temperature and starts to melt or decompose when temperature lowers to reach the predetermined temperature; and
a melting start temperature or a decomposition start temperature of the temperature-3 responsive substrate is 0° C. to 20° C.

The present invention (4) provides the agricultural composition according to any one of (1) to (3), wherein the biostimulant is a compound that induces a heat shock protein.

The present invention (5) provides the agricultural composition according to any one of (1) to (3), wherein the temperature-responsive substrate is composed of a gel comprising water and a gelling agent.

The present invention (6) provides an agricultural aqueous dispersion comprising
the agricultural composition according to any one of (1) to (3), wherein
the agricultural composition is dispersed in an aqueous solvent.

### Advantageous Effect of Invention

According to the present invention, an agricultural composition that can control the supply of the biostimulants to plants in response to the state of the high temperature stress or the state of the low temperature stress is provided.

### DESCRIPTION OF EMBODIMENTS

The present invention provides an agricultural composition comprising:
a temperature-responsive substrate that starts to melt or decompose at a predetermined temperature; and
a biostimulant that alleviates a non-biological stress of plants or promotes plant growth.

The agricultural composition of the present invention includes a biostimulant. In other words, the agricultural composition of the present invention is formulated in a state where at least the biostimulant is dispersed in a temperature-responsive substrate. In other words, the agricultural composition of the present invention includes at least the temperature-responsive substrate and the biostimulant dispersed in the temperature-responsive substrate. The agricultural composition of the present invention has two aspects: one aspect in which the temperature-responsive substrate starts to melt or decompose when the environmental temperature rises and reaches a predetermined temperature (the agricultural composition of a first aspect of the present invention), and the other aspect in which the temperature-responsive substrate starts to melt or decompose when the environmental temperature lowers and reaches a predetermined temperature (the agricultural composition of a second aspect of the present invention). In the case where the agricultural composition of the first aspect of the present invention and the agricultural composition of the second aspect of the present invention are collectively called, these compositions are described as the agricultural composition of the present invention.

The biostimulant is a blended agent that alleviates the environmental stress of plants or promotes the growth of plants by melting or decomposing the temperature-responsive substrate to supply the biostimulant to plants, soils, or nutritive solutions at the time when the environmental temperature reaches the predetermined temperature when the agricultural composition of the present invention is used by directly applying to plants or applying soils where plants grow or the nutritive solutions.

The biostimulant is a new agricultural material that has been attracting attention around the world, particularly in Europe, in recent years. The biostimulant is various substances and microorganisms that provide better physiological conditions for plants and soils. The biostimulants is characterized by providing positive effect on plants such as plant health, stress tolerance, yield and quality, and post-harvest condition and storage by utilizing natural power inherent in plants and the surrounding environment thereof.

The biostimulant is a substance or microorganism that acts on alleviating non-biological stress (environmental stress) by supplying to plants, promoting growth of plants by enhancing the plant's ability to take in nutrients, and alleviating the non-biological stress or promoting plant growth by putting the plant in a better physiological state. Examples of the non-biological stress (environmental stress) include high temperature stress, high humidity stress, salt damage stress, drought stress, low temperature stress, cold damage stress, frost damage stress, oxidative stress (damage caused by active oxygen species), physical damage (hail and wind damage), and chemical damage stress caused by pesticides. The biostimulant helps plant growth by alleviating these non-biological stresses (environmental stresses). The biostimulants also promote plant growth by improving the rhizosphere environment, for example, growth promotion of soil microorganisms, stabilizing rhizobia, increasing root volume, improving root activity, inducing hormones that regulate stomatal opening and closing, and improving dryness, thereby enhancing the ability of plants to take in nutrients. The biostimulant also alleviates the non-biological stress or promotes plant growth by activating photosynthesis, promoting flowering or fruit set, controlling transpiration, adjusting osmotic pressure, and synthesizing starch, which aphids dislike, thereby achieving the better physiological state of plants. The biostimulant also contributes to improved yield, quality, and the like by acting to alleviate the non-biological stress, to enhance the plant's ability to take in nutrients, and to achieve the better physiological state of plants. The biostimulant acts on at least one of the following three effects: “to alleviate the non-biological stress”, “to enhance the plant's ability to take in nutrients”, and “to achieve the better physiological state of plants”. Depending on the type of the biostimulants, some biostimulants are excellent at one or two of these three actions, while other biostimulants exhibit all of these three actions.

On the other hand, the pesticides alleviate the biological stress, the fertilizers supply nutrients to plants, and the soil conditioners physically, chemically, or biologically change soils. From such a viewpoint, the biostimulant differs from the pesticides, the fertilizers, and the soil conditioners.

In addition, the biostimulant does not exhibit expected effects by directly acting on individual problems in agriculture, but exhibits expected effects by enhancing the abilities of the plants themselves.

Therefore, for the agricultural composition of a first embodiment of the present invention including such a biostimulant, the biostimulant is supplied to plants when the stare where the high temperature stress is applied due to rise in the environmental temperature occurs. Therefore, the tolerance to the high temperature stress is provided to the plants, and the plants can grow even in an environment (temperature) where the high temperature stress is applied. With the agricultural composition of a second embodiment of the present invention including such a biostimulant, the biostimulant is supplied to the plants when the state where the low temperature stress due to lowering in the environmental temperature occurs. Therefore, the tolerance to the low temperature stress is provided to the plants, and the plants can grow even in an environment (temperature) where the low temperature stress is applied.

The biostimulant is not limited and appropriately selected. Examples of the biostimulant include a compound inducing heat shock proteins. Examples of the compound inducing the heat shock proteins include zerumbone, sanguinarine, salicylic acid, polyamines, geldanamycin, isothianate, trimethylglycine, perillaldehyde, citral, carotene, lycopene, zeaxanthin, cryptoxanthin, lutein, phenylethyl isothiocyanate, ursolic acid, choline, alginic acid, fulvic acid, humic acid, 5-aminolevulinic acid, oxidized glutathione, trehalose, and 2-hexanal.

The heat shock proteins are produced when cells are stressed and exhibit actions on repairing denatured proteins by binding to the denatured proteins The compound that induces the heat shock proteins induces the generation of the heat shock proteins. This improves the stress tolerance. In other words, the compound that induces the heat shock proteins is particularly effective in alleviating environmental stresses such as the high temperature stress, the high humidity stress, the salt damage stress, and the dryness stress. Zerumbone, sanguinarine, salicylic acid, polyamines, geldanamycin, isothianate, trimethylglycine, perillaldehyde, citral, carotene, lycopene, zeaxanthin, cryptoxanthin, lutein, phenylethylisothiocyanate, ursolic acid, choline, alginic acid, fulvic acid, humic acid, 5-aminolevulinic acid, oxidized glutathione, trehalose, and 2-hexanal are known to induce the heat shock proteins.

For example, when heat shock is applied to plant cells, heat shock factors are activated in the cytoplasm of the plant cells to separate into HSP70 (heat shock protein), HSP90 (heat shock protein), and HSF (heat shock factor). HSFs bind to each other to form subunits having a predetermined three-dimensional structure and migrate into the nucleus to bind to HSE sequences in the plant genome. The binding of the HSF subunit to the HSE sequence switches on the genes related to counteract the heat shock. Specifically, this can produce the heat shock proteins to repair damaged proteins, produce antimicrobial substances (antibacterial proteins) to prevent infection with pathogenic bacteria, and produce proteins that remove active oxygen to eliminate active oxygen. This increases tolerance to the environmental stress.

In addition, the compound inducing the heat shock proteins acts on the plant cells to produce HSFs. The generated HSFs are bound to each other to form the subunits having the predetermined three-dimensional structure and migrate into the nucleus to bind to HSE sequences in the plant genome. The binding of the HSF subunit to the HSE sequence switches on the related genes to counteract the heat shock to produce the heat shock proteins. As described above, the compound inducing the heat shock protein induces the production of the heat shock proteins when the compound is taken up by the plant cells.

Examples of the heat shock proteins include Heat Shock Protein 40, Heat Shock Protein 70, Heat Shock Protein 32, Heat Shock Protein 47, and Heat Shock Protein 60. In addition, the compound inducing the heat shock proteins induces the heat shock proteins in the same manner as the manner when the compound is exposed to the high temperature environment.

In the agricultural composition of the present invention, the compound inducing the heat shock proteins itself may be blended and dispersed in the temperature-responsive substrate, or the compound inducing the heat shock proteins may be blended and dispersed in the temperature-responsive substrate in the form of the blended agent including the compound as the active component. Alternatively, the compound inducing the heat shock proteins may be blended and dispersed in the temperature-responsive substrate by removing the dispersion medium in the blended agent after the blended agent including the compound inducing the heat shock proteins as the active component is mixed with the temperature-responsive substrate. Examples of the commercially available blended agents including such compound inducing the heat shock proteins as the active component include Thermozyme, Suzumidori, and SKEEPON.

The content of the compound inducing the heat shock proteins in the agricultural composition of the present invention is not particularly limited and can be appropriately selected depending on the environment in which the agricultural composition is used, the type of the temperature-responsive substrate, and the like. The content is preferably 0.00005% by mass to 1.0% by mass and more preferably 0.0001% by mass to 0.5% by mass based on the 3 active component, that is, based on the compound inducing the heat shock proteins.

Examples of the biostimulants include zerumbone, analogues of zerumbone, derivatives of zerumbone, salts of zerumbone, salts of the analogues of zerumbone, and salts of the derivatives of zerumbone. Zerumbone (6Cl, 7Cl) is (2E,6E,10E)-2,6,9,9-teuramethylcycloundeca-2,6,10-tríen-1-one (Empirical Formula (Hill Notation): C₁₅H₂₂O, CAS Registry Number: 471-05-6),

which is a compound represented by the following formula (1):

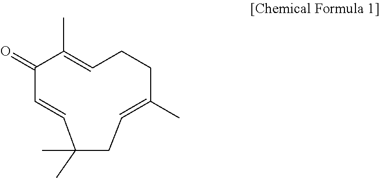 [SMILES: C/C1=C\CC(C)(C)/C=C/C(=O)/C(C)=C/CC1]

In addition, as the analogues of zerumbone, α-humulene:

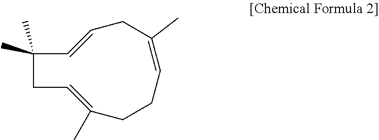

### β-Caryophyllene:

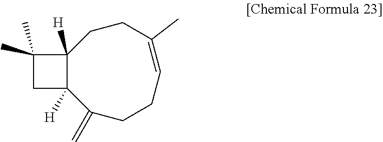

### Germakren D:

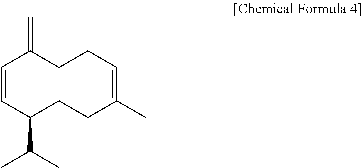

Caryophyllene oxide; and

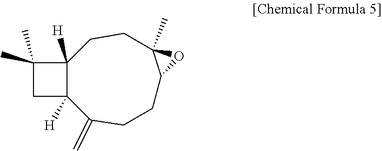

### Kobusone:

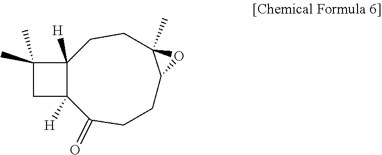

may be exemplified. Examples of the salts of zerumbone, the salts of the analogues of zerumbone, and salts of the derivatives of zerumbone include, but are not particularly limited to, inorganic acid salts such as carbonates, hydrochlorides, nitrates, sulfates, and phosphates, and organic acid salts such as acetates, propionates, butyrates, and other aliphatic acid salts. Zerumbone, the analogues of zerumbone, the derivatives of zerumbone, the salts of zerumbone, the salts of the analogues of zerumbone, and the salts of the derivatives of zerumbone are particularly effective in alleviating the environmental stresses such as the high temperature stress, the low temperature stress, the high humidity stress, the salt damage stress, and the dryness stress.

Zerumbone and the analogues thereof are included in the essential oil components of bitter ginger at 80% by mass to 90% by mass and are obtained as extracts or crushed products of ginger and ginger plants such as turmeric. Zerumbone and the analogues thereof are also obtained as extracts or crushed products of hop, clove, and lavender.

In the agricultural composition of the present invention, zerumbone, the analogues of zerumbone, the derivatives of zerumbone, the salts of zerumbone, the salts of the analogues of zerumbone, and the salts of the derivatives of zerumbone themselves may be blended and dispersed in the temperature-responsive substrate, or zerumbone, the analogues of zerumbone, the derivatives of zerumbone, the salts of zerumbone, the salts of the analogues of zerumbone, and the salts of the derivatives of zerumbone may be blended and dispersed in the temperature-responsive substrate in the form of the blended agent including these compounds as the active components. Alternatively, zerumbone, the analogues of zerumbone, the derivatives of zerumbone, the salts of zerumbone, the salts of the analogues of zerumbone, or the salts of the derivatives of zerumbone may be blended and dispersed in the temperature-responsive substrate by removing the dispersion medium in the blended agent after the blended agent including zerumbone, the analogues of zerumbone, the derivatives of zerumbone, the salts of zerumbone, the salts of the analogues of zerumbone, or the salts of the derivatives of zerumbone as the active components is mixed with the temperature-responsive substrate. Examples of such a blended agent including zerumbone, the analogues of zerumbone, the derivatives of zerumbone, the salts of zerumbone, the salts of the analogues of zerumbone, or the salts of the derivatives of zerumbone as the active components include Stress Free Z (registered trademark) (manufactured by Fuso Chemical Co., Ltd.) and Stress Free HE (registered trademark) (manufactured by Fuso Chemical Co., Ltd.).

The content of zerumbone, the analogues of zerumbone, the derivatives of zerumbone, the salts of zerumbone, the salts of the analogues of zerumbone, and the salts of the derivatives of zerumbone in the compositions for agriculture of the present invention is not particularly limited and is appropriately selected depending on the environment in which the agricultural composition is used, the type of temperature-responsive substrate, and the like. The content is preferably 0.00005% by mass to 1.0% by mass and more preferably 0.0001% by mass to 0.5% by mass based on the active components. In the case where the agricultural composition of the present invention includes, as the biostimulant, one kind selected from the group consisting of zerumbone, the analogue of zerumbone, the derivative of zerumbone, the salt of zerumbone, the salt of the analogue of zerumbone, and the salt of the derivative of zerumbone, the amount of the active component refers to the content of one kind of these compounds. In the case where the agricultural composition of the present invention includes two or more kinds of the compounds selected from the group consisting of zerumbone, the analogues of zerumbone, the derivatives of zerumbone, the salts of zerumbone, the salts of the analogues of zerumbone, and the salts of the derivatives of zerumbone are included, the amount of the active components refers to the total amount of these zerumbone, the analogues of zerumbone, the derivatives of zerumbone, the salts of zerumbone, the salts of the analogues of zerumbone, and the salts of the derivatives of zerumbone.

Examples of the biostimulant include glycine betaine (also called trimethylglycine), derivatives of glycine betaine, salts of glycine betaine, and salts of the derivatives of glycine betaine. Examples of the salts of glycine betaine include, but are not limited to, inorganic acid salts such as carbonates, hydrochlorides, nitrates, sulfates, and phosphate, and organic acid salts such as acetates, propionates, butyrates, and other aliphatic acid salts. Glycine betaine, the 1l derivatives of glycine betaine, the salts of glycine betaine, and the salts of the derivatives of glycine betaine are particularly effectively acts on alleviating environmental stresses such as the high temperature stress, the low temperature stress, the high humidity stress, the salt damage stress, and the dryness stress.

In the agricultural composition of the present invention, glycine betaine, the derivatives of glycine betaine, the salts of glycine betaine, and the salts of the derivatives of glycine betaine themselves may be blended and dispersed in the temperature-responsive substrate, or glycine betaine, the derivatives of glycine betaine, the salts of glycine betaine, and the salts of the derivatives of glycine betaine may be blended and dispersed in the temperature-responsive substrate in the form of the blended agent including these compounds as the active components. Alternatively, glycine betaine, the derivatives of glycine betaine, the salts of glycine betaine, and the salts of the derivatives of glycine betaine may be blended and dispersed in the temperature-responsive substrate by removing the dispersion medium in the blended agent after the blended agent including glycine betaine, the derivatives of glycine betaine, the salts of glycine betaine, and the salts of the derivatives of glycine betaine as the active components is mixed with the temperature-responsive substrate. Examples of such blended agent including glycine betaine, the derivatives of glycine betaine, the salts of glycine betaine, and/or the salts of the derivatives of glycine betaine as the active components include Sakata Liquid Fertilizer GB (registered trademark) (Sakata Seed Corporation).

The content of glycine betaine, the derivatives of glycine betaine, the salts of glycine betaine, and the salts of the derivatives of glycine betaine in the compositions for agriculture of the present invention is not particularly limited and is appropriately selected depending on the environment in which the agricultural composition is used, the type of temperature-responsive-substrate, and the like. The content is preferably 0.00005% by mass to 1.0% by mass and more preferably 0.0001% by mass to 0.5% by mass based on the active components. In the case where the agricultural composition of the present invention includes, as the biostimulant, one kind selected from the group consisting of glycine betaine, the derivatives of glycine betaine, the salts of glycine betaine, and the salts of the derivatives of glycine betaine, the amount of the active component refers to the content of one kind of these compounds. In the case where the agricultural composition of the present invention includes two or more kinds of the compounds selected from the group consisting of glycine betaine, the derivatives of glycine betaine, the salts of glycine betaine, and the salts of the derivatives of glycine betaine are included, the amount of the active components refers to the total amount of these glycine betaine, the derivatives of glycine betaine, the salts of glycine betaine, and the salts of the derivatives of glycine betaine.

Examples of the biostimulant include sanguinarine, derivatives of sanguinarine, salts of sanguinarine, and salts of the derivatives of sanguinarine. Sanguinarine is 13-methyl-[1,3]benzodioxolo[5,6-c]-1,3-dioxolo[4,5-i]phenanthridinium (CAS no: 2447-54-3). Examples of the salts of sanguinarine include, but are not particularly limited to, inorganic acid salts such as carbonates, hydrochlorides, nitrates, sulfates, and phosphate, and organic acid salts such as acetates, propionates, butyrates, and other aliphatic acid salts. Sanguinarine, the derivatives of sanguinarine, the salts of sanguinarine, and the salts of the derivatives of sanguinarine are particularly effectively acts on alleviating environmental stresses such as the high temperature stress, the low temperature stress, the high humidity stress, the salt damage stress, and the dryness stress.

Sanguinarine and the salts of sanguinarine may be derived from natural sources such as natural extracts, chemically synthesized products, or derived from microorganisms by microbial fermentation methods. Sanguinarine is included in the plant parts of plume poppy (Macleaya cordata), California poppy (Eschscholzia californica), celandine (Chelidonium majus), and bloodroot (Sanguinaria canadensis), which are kinds of poppy. Sanguinarine is obtained by extracting sanguinarine as the active component from such plants including sanguinarine or the salts thereof.

In the agricultural composition of to the present invention, sanguinarine, the derivatives of sanguinarine, the salts of sanguinarine, and the salts of the derivatives of sanguinarine themselves may be blended and dispersed in the temperature-responsive substrate, or sanguinarine, the derivatives of sanguinarine, the salts of sanguinarine, and the salts of the derivatives of sanguinarine may be blended and dispersed in the temperature-responsive substrate in the form of the blended agent including these compounds as the active components. Alternatively, sanguinarine, the derivatives of sanguinarine, the salts of sanguinarine, and the salts of the derivatives of sanguinarine may be blended and dispersed in the temperature-responsive substrate by removing the dispersion medium in the blended agent after the blended agent including sanguinarine, the derivatives of sanguinarine, the salts of sanguinarine, and the salts of the derivatives of sanguinarine as the active components is mixed with the temperature-responsive substrate. Examples of the blended agent including such sanguinarine, the derivatives of sanguinarine, the salts of sanguinarine and/or the salts of the derivatives of sanguinarine as the active components include Thermozyme (registered trademark) (manufactured by Fujimikogyo Co., Ltd.).

The content of sanguinarine, the derivatives of sanguinarine, the salts of sanguinarine, and the salts of the derivatives of sanguinarine in the compositions for agriculture of the present invention is not particularly limited and is appropriately selected depending on the environment in which the agricultural composition is used, the type of temperature-responsive substrate, and the like. The content is preferably 0.00005% by mass to 1.0% by mass and more preferably 0.0001% by mass to 0.5% by mass based on the active components. In the case where the agricultural composition of the present invention includes, as the biostimulant, one kind selected from the group consisting of sanguinarine, the derivatives of sanguinarine, the salts of sanguinarine, and the salts of the derivatives of sanguinarine, the amount of the active component refers to the content of one kind of these compounds. In the case where the agricultural composition of the present invention includes two or more kinds of the compounds selected from the group consisting of sanguinarine, the derivatives of sanguinarine, the salts of sanguinarine, and the salts of the derivatives of sanguinarine are included, the amount of the active components refers to the total amount of these sanguinarine, the derivatives of sanguinarine, the salts of sanguinarine, and the salts of the derivatives of sanguinarine.

Examples of the biostimulant include amino acids such as choline, alginic acid, fulvic acid, humic acid, and 5-aminolevulinic acid. Fulvic acid, for example, effectively acts on improving nutrient absorption ability of plants. Choline is absorbed by plants at a rapid speed and effectively acts on rapid nutrient replenishment. The amino acids activate useful soil microorganisms and promote soil aggregation, thereby effectively acting on improving the environment around roots. Examples of the commercially available products using these compounds as the active components include RIKIDUS (registered trademark) (manufactured by HYPONeX JAPAN Ltd.), Morning Fresh (registered trademark) (manufactured by Agro Kanesho CO., LTD.), Hi-Tac C (registered trademark) (manufactured by Agro Kanesho CO., LTD.), Atonic (registered trademark) (manufactured by ASAHI KAGAKU KOGYO CO., LTD.), Revital (registered trademark) (manufactured by OAT Agrio Co., Ltd.), FullBody (registered trademark) (manufactured by OAT Agrio Co., Ltd.), ALA-FeSTA (registered trademark) (manufactured by Sakata Seed Corporation), Pentakeep (registered trademark) (manufactured by SEIWA CO., LTD.). AzLiquid (registered trademark) (manufactured by Denka Company Limited.), Azomine (registered trademark) (manufactured by Denka Company Limited.), Bombardier (registered trademark) (manufactured by HYPONeX JAPAN CORP., LTD.). Phyto-O-Two (registered trademark)(manufactured by Phytochrome Inc.), ROOTS Dry Soluble (manufactured by Bichemic Japan Ltd.), Organamine DA (registered trademark) (manufactured by Pulsar International Corporation), Jirikinomoto (registered trademark) (manufactured by P.I.C. Bio Inc.), and Royal Humic Acid Granule (registered trademark) (manufactured by ROYAL INDUSTRIES CO., LTD). The content of choline, 5-aminolevulinic acid, alginic acid, fulvic acid, humic acid, and amino acids in the agricultural composition of the present invention is not particularly limited and is appropriately selected depending on the environment in which the agricultural composition is used, the type of temperature-responsive substrate, and the like. The content is preferably 0.00005% by mass to 1.0% by mass and more preferably 0.0001% by mass to 0.5% by mass based on the active components. In the case where the agricultural composition of the present invention includes two or more kinds of the biostimulants, the amount of the active components refers to the total amount of these biostimulants. In the agricultural composition of the present invention, these biostimulants themselves may be blended and dispersed in the temperature-responsive substrate or these biostimulants may be blended and dispersed in the temperature-responsive substrate in the form of the blended agent including these biostimulants as the active components. Alternatively, these biostimulants may be blended and dispersed in the temperature-responsive substrate by removing the dispersion medium in the blended agent after the blended agent including these biostimulants as the active components is mixed with the temperature-responsive substrate.

Examples of the biostimulant include oxidized glutathione, trehalose, and 2-hexanal. Oxidized glutathione, trehalose, and 2-hexanal are effectively act on alleviating the environmental stresses.

Examples of the commercially available biostimulants or blended agents including the biostimulants include Tetsuriki Agri (registered trademark) (manufactured by Aichi Steel Corporation) and Tetsuriki Tore Plus (registered trademark) (manufactured by Aichi Steel Corporation) including iron as the active component; Harmozyme (registered trademark) (manufactured by Arysta LifeScience Corporation) including corn extract as the active component: Algamix (registered trademark) (manufactured by OAT Agrio Co., Ltd.) and Kelpac 66 (registered trademark) (manufactured by Royal Industries Inc.) including seaweed extract as the active component; Kaneka Peptide (registered trademark) (manufactured by Kaneka Corporation) and Kaneka Fertilizer (registered trademark) (manufactured by Kaneka Corporation) including oxidized glutathione as the active component; SANNONIC (registered trademark) (manufactured by Sanyo Chemical Industries. Ltd.) including surfactant as the active component; Oxopower 5 (registered trademark) (manufactured by TAKII & CO., LTD), MOX (registered trademark)(manufactured by Hodogaya Chemical Co., Ltd.), and Neocal Oxo (registered trademark) (manufactured by Hodogaya Chemical Co., Ltd.) including oxygen supply agents as the active components; a blended agent including trehalose as the active component (manufactured by Hayashibara Co., Ltd.); Suzumidori (registered trademark) (manufactured by Phytochrome Inc.) including 2-hexanal as the active component; Manda 31 (registered trademark) (manufactured by Manda Fermentation Co., Ltd.) including a plant materials as the active component; Agri Kakumei (registered trademark) (manufactured by Menicon Co., Ltd.) including a plant fiber degrading enzyme as the active component; and Takiitreace (registered trademark) (manufactured by TAKII & CO., LTD) including trehalose as the active component. The content of these blended agents in the agricultural composition of the present invention is not particularly limited and is appropriately selected depending on the environment in which the agricultural composition is used, the type of temperature-responsive substrate, and the like. The content is preferably 0.00005% by mass to 1.0% by mass and more preferably 0.0001% by mass to 0.5% by mass based on the active components. In the case where the agricultural composition of the present invention includes two or more kinds of the biostimulants, the amount of the active components refers to the total amount of these biostimulants. In the agricultural composition of the present invention, these biostimulants themselves may be blended and dispersed in the temperature-responsive substrate or these biostimulants may be blended and dispersed in the temperature-responsive substrate in the form of the blended agent including these biostimulants as the active components. Alternatively, these biostimulants may be blended and dispersed in the temperature-responsive substrate by removing the dispersion medium in the blended agent after the blended agent including these biostimulants as the active components is mixed with the temperature-responsive substrate.

Examples of the biostimulant include microorganisms that contribute to alleviating the non-biological stress of plants or promoting plant growth. The content of the microorganisms in the compositions for agriculture of the present invention is not particularly limited and is appropriately selected depending on the environment in which the agricultural composition is used, the type of temperature-responsive substrate, and the like. The content is preferably 0.00005% by mass to 1.0% by mass and more preferably 0.0001% by mass to 0.5% by mass based on the active components.

The content of the biostimulant in the agricultural composition of the present invention is not particularly limited and is appropriately selected depending on the environment in which the agricultural composition is used, the type of temperature-responsive substrate, and the like. The content is preferably 0.00005% by mass to 1.0% by mass and more preferably 0.0001% by mass to 0.5% by mass based on the active components, that is, based on the biostimulant.

The agricultural composition of the present invention is formed of the temperature-responsive substrate. In other words, in the agricultural composition of the present invention, the skeleton is the temperature-responsive substrate.

In the present invention, the temperature-responsive substrate refers to a material that starts to melt or decompose when the agricultural composition of the present invention is directly used for plants or used in soils where plants are grown and the environmental temperature reaches a predetermined temperature. In the agricultural composition of the present invention, when the environmental temperature of the temperature-responsive substrate forming the agricultural composition reaches a predetermined environmental temperature, the temperature-responsive substrate starts to melt or decompose, a part of the temperature-responsive substrate starts to disintegrate, the biostimulant included in the temperature-responsive substrate is released from the agricultural composition, and the biostimulant is supplied to plant or soils.

The agricultural composition of the first aspect of the present invention is the aspect used to provide tolerance to the high temperature stress to plants in the case where the high temperature stress is applied due to rise in the environmental temperature. In the agricultural composition of the first aspect of the present invention, when the environmental temperature rises and the environmental temperature reaches the predetermined temperature, the temperature-responsive substrate starts to melt or decompose. In the agricultural composition of the first aspect of the present invention, the temperature at which the release of the biostimulant from the agricultural composition is started, that is, the predetermined temperature, is a temperature at which the biostimulant is required to be supplied to plant in order to provide the tolerance of the high temperature stress to plants, and is appropriately selected depending on the types of the plant to be grown, environments, growing season, and other factors. For example, if the supply of the biostimulant to the plant is started when the temperature reaches a temperature at which the plant cannot grow due to the high temperature stress, time for the plant to obtain the tolerance may be insufficient, so that the predetermined temperature is set slightly lower than the temperature at which the plant cannot grow due to the high temperature stress. The agricultural composition of the first aspect of the present invention uses a temperature-responsive substrate that starts to melt or decompose at the predetermined temperature. In other words, in the agricultural composition of the first aspect of the present invention, a material that does not melt or decompose at a temperature lower than the predetermined temperature and starts melting or decomposing when the temperature rises to reach the predetermined temperature, that is, the temperature-responsive substrate for which the predetermined temperature is a melting start temperature or the temperature-responsive substrate for which the predetermined temperature is a decomposition start temperature is used.

The agricultural composition of the second aspect of the present invention is the aspect used to provide tolerance to the low temperature stress to plants in the case where the low temperature stress is applied due to lowering in the environmental temperature. In the agricultural composition of the second aspect of the present invention, when the environmental temperature lowers and the environmental temperature reaches the predetermined temperature, the temperature-responsive substrate starts to melt or decompose. In the agricultural composition of the second aspect of the present invention, the temperature at which the release of the biostimulant from the agricultural composition is started, that is, the predetermined temperature, is a temperature at which the biostimulant is required to be supplied to plant in order to provide the tolerance of the low temperature stress to plants, and is appropriately selected depending on the types of the plant to be grown, environments, growing season, and other factors. For example, if the supply of the biostimulant to the plant is started when the temperature reaches a temperature at which the plant cannot grow due to the low temperature stress, time for the plant to obtain the tolerance may be insufficient, so that the predetermined temperature is set slightly higher than the temperature at which the plant cannot grow due to the low temperature stress. The agricultural composition of the second aspect of the present invention uses a temperature-responsive substrate that starts to melt or decompose at the predetermined temperature. In other words, in the agricultural composition of the second aspect of the present invention, a material that does not melt or decompose at a temperature higher than the predetermined temperature and starts melting or decomposing when the temperature lowers to reach the predetermined temperature, that is, the temperature-responsive substrate for which the predetermined temperature is a melting start temperature or the temperature-responsive substrate for which the predetermined temperature is a decomposition start temperature is used.

Examples of temperature-responsive substrates include temperature-responsive substrates that start melting at the predetermined temperature. The predetermined temperature, that is, the melting start temperature of the temperature-responsive substrate is preferably 0° C. to 60° C. and more preferably 5° C. to 55° C. In the case where plants are grown in a high temperature environment, for example, the temperature inside a plastic greenhouse when plants are grown in a plastic greenhouse in summer sometimes reaches 35° C. to 45° C. Therefore, in the case where the agricultural composition of the first aspect of the present invention is used in the high temperature environment such as inside a plastic greenhouse in summer, the predetermined temperature, that is, the melting start temperature of the temperature-responsive substrate is preferably 30° C. to 60° C. and more preferably from 35° C. to 55° C. In the case where plants are grown in the low-temperature environment, for example, in the cultivation of Arabidopsis thaliana, a low temperature of 0° C. to 15° C. decreases the activity of enzymes and lowers cell metabolism, so that in the case where the agricultural composition of the second aspect of the present invention is used in a low-temperature environment, the predetermined temperature, that is, the melting start temperature of the temperature-responsive substrate is preferably 0° C. to 20° C. and more preferably 5° C. to 15° C.

In the present invention, the melting start temperature of the temperature-responsive substrate is measured by a test tube inversion method in the following procedure.

### <In Case of Temperature-Responsive Substrate for Agricultural Composition of First Aspect of Present Invention>

A test tube having an outer shape of 15 mm and a height of 150 mm is filled with 5 g of the target to be measured. Subsequently, the test tube containing the target to be measured is placed vertically in a hot water bath and heated to rise the temperature of the test tube. While the temperature of the test tube is being raised, the flow state of the content is checked by tilting the test tube together with visual inspection. When the test tube is tilted at 15 degrees from the vertical, the temperature at which the target to be measured becomes liquid and flows toward the mouth side is defined as the melting start temperature.

### <In Case of Temperature-Responsive Substrates for Agricultural Composition of Second Aspect of Present Invention>

A test tube having an outer shape of 15 mm and a height of 1SQ mm is filled with 5 g of the target to be measured. Subsequently, the test tube containing the target to be measured is placed vertically in ice water and cooled to lower the temperature of the test tube. While the temperature of the test tube is being lowered, the flow state of the content is checked by tilting the test tube together with visual inspection. When the test tube is tilted at 15 degrees from the vertical, the temperature at which the target to be measured becomes liquid and flows toward the mouth side is defined as the melting start temperature.

Examples of materials composing the temperature-responsive substrate for the agricultural composition of the first aspect of the present invention include fats and oils, hardened oils, and fats and oils including hardened oils. Examples of the fats and oils include palm oil, soybean oil, palm kernel oil, coconut oil, olive oil, rapeseed oil, butter, margarine, beef fat, chicken oil, and pork oil. Examples of the hardened oils include fats and oils such as palm oil, soybean oil, palm kernel oil, coconut oil, olive oil, rapeseed oil, butter, margarine, beef fat, chicken oil, and pork oil in which some of or all unsaturated bonds in the fats and oils are hydrogenated. Examples of the fats and oils including hardened oils include mixtures of the above fats and oils and the above hardened oils. The fats and oils may be one or a combination of two or more, the hardened oils may be one or a combination of two or more, and the fats and oils including the hardened oil may be one or a combination of two or more.

The melting points of the fats and oils, the hardened oils, and the fats and oils including the hardened oils used in the temperature-responsive substrate for the agricultural composition of the first aspect of the present invention are preferably 30° C. to 60° C.

The type of the fats and oils, the hardened oils, and the fats and oils including the hardened oils used in the temperature-responsive substrate for the agricultural composition of the first aspect of the present invention and the mixing ratio of the tats and oils and the hardened oils are appropriately selected depending on the temperature at which the release of the biostimulant from the agricultural composition is started, that is, the predetermined temperature. In other words, the melting start temperature of the temperature-responsive substrate can be adjusted to the predetermined temperature by selecting the type of the fats and oils, the hardened oils, and the fats and oils including the hardened oils according to the temperature-responsive substrate and the mixing ratio of the fats and oils and the hardened oils.

Examples of materials composing the temperature-responsive substrate for the agricultural composition of the first aspect of the present invention include a gel including water and a gelling agent.

Examples of the gelling agent used in temperature-responsive substrate for the agricultural composition of the first aspect of the present invention include proteins such as gelatin or hyaluronic acid, which forms a gel by mixing these compounds with water, heating to a gelling temperature, and thereafter cooling. The proteins used as the gelling agent may 3 be one or a combination of two or more.

Gelatin is a compound obtained by heating collagen, which is the main component of animal skins, bones, and tendons, and performing extraction. A method for producing gelatin is not particularly limited. Examples of gelatin include a product produced by treating skins, bones, and tendons of cows, pigs, chickens, fish, and the like as raw materials with acid or alkali to provide crude collagen, and thereafter extracting the crude collagen with heat. Gelatin may also be, for example, hydrolyzed products, oxygenated products, or gelatin derivatives (for example, acylated gelatin).

The type of the protein used as the gelling agent for the temperature-responsive substrate for the agricultural composition of the first aspect of the present invention and combination and mixing ratio thereof when two or more proteins are used are appropriately selected depending on the temperature at which the release of the biostimulant from the agricultural composition is started, that is, the predetermined temperature. In other words, the melting start temperature of the temperature-responsive substrate can be adjusted to the predetermined temperature by selecting the type of the protein used as the gelling agent and combination and mixing ratio thereof when two or more types are used.

Examples of the gelling agent used in the temperature-responsive substrate for the agricultural composition of the first aspect of the present invention include thickening polysaccharides such as locust bean gum, xanthan gum, carrageenan, agar, tar gum, gellan gum, or pectin, which forms a get by mixing these compounds with water, heating to a gelling temperature, and thereafter cooling. The thickening polysaccharides used as the gelling agent may be one or a combination of two or more.

The type of the thickening polysaccharides used as the gelling agent for the temperature-responsive substrate for the agricultural composition of the first aspect of the present invention and the combination and mixing ratio thereof when two or more types of the thickening polysaccharides are used are appropriately selected depending on the temperature at which the biostimulant releases from the agricultural composition is started, that is, the predetermined temperature. In other words, the melting start temperature of the temperature-responsive substrate can be adjusted to the predetermined temperature by selecting the type of the thickening polysaccharides used as the gelling agent and combination and mixing ratio thereof when two or more types are used.

Examples of the gelling agent used for the temperature-responsive substrate for the agricultural composition of the first aspect of the present invention include a mixture of one or more types of the proteins such as gelatin and hyaluronic acid and one or more types of the thickening polysaccharides such as locust bean gum, xanthan gum, carrageenan, agar, tara gum, gellan gum, and pectin, which forms a gel by mixing these compounds with water, heating to a gelling temperature, and thereafter cooling.

In the case where the mixture of the protein and the thickening polysaccharide is used to as the gelling agent used for the temperature-responsive substrate for the agricultural composition of the first aspect of the present invention, the mixture of the protein and the thickening polysaccharide is preferably used as the gelling agent from the viewpoint of easily adjusting the melting start temperature of the temperature-responsive substrate, because the melting start temperature of the temperature-responsive substrate can be adjusted to the predetermined temperature by selecting the type of the protein, the type of the thickening polysaccharide, and the mixture ratio thereof.

The type of protein, the type of thickening polysaccharide, and the mixing ratio thereof used as the gelling agents for the temperature-responsive substrate for the agricultural composition of the first aspect of the present invention are appropriately selected depending on the temperature at which the release of the biostimulant from the agricultural composition is started, that is, the predetermined temperature.

The content of water in the gel for the temperature-responsive substrate for the agricultural composition of the first aspect of the present invention is appropriately selected. The content is, for example, 0.10% by mass to 10.0% by mass.

Examples of materials composing the temperature-responsive substrate for the agricultural composition of the second aspect of the present invention include a gel including water and a gelling agent.

Examples of the gelling agent used in the temperature-responsive substrate for the agricultural composition of the second aspect of the present invention include one or more types of the thickening polysaccharides of methylcellulose and hydroxypyropylmethylcellulose, which is dissolved when mixed with heated water and cooled, and forms a gel by temperature rise. The thickening polysaccharides used as the gelling agent may be one or a combination of two or more.

The type of materials composing the temperature-responsive substrate for the agricultural composition of the second aspect of the present invention and the mixing ratio when a plurality of materials are used are appropriately selected depending on the temperature at which the release of the biostimulant from the agricultural composition is started, that is, the predetermined temperature. In other words, the melting start temperature of the temperature-responsive substrate can be adjusted to the predetermined temperature by selecting the type of the materials composing the temperature-responsive substrate and mixing ratio thereof when two or more materials are used.

The content of water in the gel for the temperature-responsive substrate for the agricultural composition of the second aspect of the present invention is appropriately selected. The content is, for example, 0.10% by mass to 10.0% by mass.

Examples of the temperature-responsive substrate include temperature-responsive substrates that starts decomposition at the predetermined temperature. In the present invention, “start decomposition” refers to that a part of the compound composing the temperature-responsive substrate starts to decompose when the environmental temperature reaches the predetermined temperature. The predetermined temperature, that is, the temperature at which the temperature-responsive substrate starts to decompose is preferably 0° C. to 60° C. and more preferably 5° C. to 55° C. In the case where plants are grown in the high temperature environment, for example, the temperature inside a plastic greenhouse when plants are grown in the plastic greenhouse in summer sometimes reaches 35° C. to 45° C. Therefore, in the case where the agricultural composition of the first aspect of the present invention is used in the high temperature environment such as in a plastic greenhouse in summer, the predetermined temperature, that is, the temperature at which the temperature-responsive substrate starts decomposition is preferably 30° C. to 60° C. and more preferably 35° C. to 55° C. In the case where plants are grown in the low-temperature environment, for example, in the cultivation of Arabidopsis thaliana, the low temperature of 0° C. to 15° C. decreases the activity of enzymes and lowers cell metabolism, so that when the agricultural composition of the second aspect of the present invention is used in the low-temperature environment, the predetermined temperature, that is, the temperature at which the temperature-responsive substrate starts to decompose is preferably 0° C. to 20° C. and more preferably 5° C. to 15° C.

The agricultural composition of the present invention may include spreading agents. The spreading agents enhance the wettability, adhesion, spreading properties, and suspension properties of the agricultural composition and function to perform uniform adhesion of the agricultural composition. In particular, in the case where the agricultural composition of the present invention is used by directly applying to plants to preform direct adhesion to leaves, stems, and other parts of plants, a dispersion in which the agricultural composition of the present invention is dispersed in an aqueous solvent is applied to plants to adhere to the plants. The spreading agent is used to allow the agricultural composition of the present invention to adhere uniformly at a moderate density on the surface of the plants when the dispersion including the agricultural composition of the present invention is applied to plants.

3 The spreading agent is not particularly limited as long as the spreading agent can be used for agricultural applications. Examples of the spreading agent include nonionic surfactants including polyoxyethylene alkyl phenyl ether-based surfactants, polyoxyethylene alkyl ether-based surfactant, polyalkylene glycol alkyl ether-based surfactants, polyoxyethylene fatty acid ester-based surfactants, polyoxyethylene resin acid ester-based surfactants, polyoxyethylene hexitane fatty acid ester-based surfactants, sorbitan fatty acid ester-based surfactants, and silicone-based surfactants as active components; anionic surfactants including naphthyl methanesulfonate-based surfactants, lignin sulfonate-based surfactants, alkyl sulfosuccinate-based surfactants as active components; and cationic surfactants such as tetraalkylammonium salt-based surfactants. Examples of commercially available spreading agents include Approach BI (registered trademark, manufactured by Maruwa Bio-Chemical Co., Ltd.), Squash (registered trademark, manufactured by Maruwa Bio-Chemical Co., Ltd.), Surfactant WK (registered trademark, manufactured by Maruwa Bio-Chemical Co., Ltd.), Mix Power (registered trademark, manufactured by Syngenta Japan K. K.), and Supply (registered trademark, manufactured by OAT Agrio Co., Ltd.).

The content of the spreading agent in the agricultural composition of the present invention is appropriately selected and is, for example, 0.10% by mass to 40.0% by mass, preferably 0.10% by mass to 25.0% by mass, and more preferably 1.0% by mass to 20.0% by mass.

The agricultural composition of the present invention may include regulators, solvents, emulsifiers, preservatives, antioxidants, fragrances, dyes, pigments, stabilizers, and other compounds, if necessary.

The size of the agricultural composition of the present invention is not particularly limited and is appropriately selected depending on methods for use. For example, in the case where a granular (solid) compound for agriculture is applied onto soils in which plants are grown, the compound for agriculture of the present invention is preferably granular products having an average particle diameter of 0.001 mm to 5.0 mm and more preferably granular products having an average particle diameter of 0.01 mm to 1.0 mm from the viewpoint of easy handling. In the case where the agricultural composition of the present invention is directly applied to plants in the form of an agricultural aqueous dispersion in which the agricultural composition of the present invention is dispersed in an aqueous solvent to perform adhesion of the agricultural composition of the present invention on the leaves and stems of plants, the average particle diameter of the agricultural composition of the present invention is preferably from 0.001 mm to 5.0 mm and more preferably from 0.01 mm to 1.0 mm from the viewpoint of better uniformity and adhesion. The above average particle diameter is an example based on the method for use and the size of the agricultural composition of the present invention is 3 not limited to this example.

The method for producing the agricultural composition of the first aspect of the present invention is not particularly limited. Examples of the method include a method including dissolving or dispersing the biostimulant in water, heating the resulting liquid including the biostimulant, adding the gelling agent thereto, stirring and mixing, and thereafter cooling to form a gel to produce the agricultural composition of the present invention; and a method including heating the fats and oils, the hardened oils, or the fats and oils including the hardened oils to melt, adding the biostimulant thereto, stirring and mixing, and thereafter cooling to produce the agricultural composition of the present invention.

The method for producing the agricultural composition of the second aspect of the present invention is not particularly limited. Examples of the method include a method including dissolving or dispersing the biostimulant in water, heating the resulting liquid including the biostimulant, adding the gelling agent thereto, stirring and mixing, cooling to dissolve, and thereafter rising a temperature to form a gel to produce the agricultural composition of the present invention.

The method of producing the agricultural composition includes a method including dissolving or dispersing the temperature-responsive materials that start decomposition at the decomposition start temperature and the biostimulant in a solvent, converting the resultant mixture into a paste-like or clay-like form, and thereafter granulating to produce the agricultural composition of the present invention.

The agricultural composition of the present invention is previously directly applied to plants or previously applied to soils where plants are grown before the environmental temperature reaches a temperature at which stress is applied to plants in the case where the stress is applied to plants due to environmental temperature changes during the cultivation of plants, whereby when the environmental temperature changes and reaches “the temperature at which the biostimulant is required to be supplied to plants in order to provide tolerance to stress for plants caused by temperature change”, that is, the predetermined temperature, the temperature-responsive substrate composing the agricultural composition of the present invention starts melting or decomposing, and the biostimulant can be supplied from the agricultural composition of the present invention.

With the agricultural composition of the first aspect of the present invention, direct application of the agricultural composition of the first aspect of the present invention to plants or application onto soils where plants are grown before a predicted day when the environmental temperature reaches a temperature at which the high temperature stress is applied allows the temperature-responsive substrate composing the agricultural composition of the first aspect of the present invention to start to melt or decompose and thus the biostimulant to be supplied from the agricultural composition of the first aspect of the present invention when the environmental temperature reaches “the temperature at which the biostimulant is required to be supplied to plants in order to provide tolerance to the high temperature stress for plants”, that to is, the predetermined temperature. Therefore, the biostimulant can be timely supplied when plants require the biostimulant.

When the agricultural composition of the first aspect of the present invention is directly applied to the plants or applied to soils in which the plants are grown before the day on which the environmental temperature is expected to cause the high temperature stress. Thereafter, however, contrary to the expectations, even when the environmental temperature continues to be not high enough to cause the high temperature stress to the plants for a while, the temperature-responsive substrate composing the agricultural composition of the first aspect of the present invention does not start melting or decomposing until the temperature reaches “the temperature at which the biostimulant is required to be supplied to plants in order to provide tolerance to the high temperature stress for plants”, that is, the predetermined temperature, and therefore the biostimulant is not released from the agricultural composition of the first aspect of the present invention. Consequently, the biostimulant is not wasted even when the agricultural composition of the first aspect of the preset invention is applied excessively early.

In plastic greenhouse cultivation in summer, the maximum temperature rises as the days go by and the temperature inside the plastic greenhouse becomes higher and higher as the days go by. At a certain point, the temperature reaches a temperature where the plants cannot tolerate the high temperature stress. Therefore, before such weather occurs, cultivation in plastic greenhouses is required to be stopped in that season. However, summer weather is difficult to accurately predict, and thus (1) a state where the day when the temperature reaches a temperature at which plants cannot tolerate the high temperature stress will be expected to come soon, so that the cultivation for the season gives up early, but in fact, the day when the temperature reaches a temperature at which the plants cannot tolerate the high temperature stress comes later than expected, so that the plants can be grown and harvested one more time when analyzed later may occur, and on the other hand. (2) a state where sufficient days are expected to remain until the temperature reaches a temperature at which plants cannot tolerate the high temperature stress and cultivation is stated once more, but in fact, the day when the plants cannot tolerate the high temperature stress comes unexpectedly early, and thus the plants cannot be grown due to the high temperature stress before harvest and the harvest cannot be performed may occur. In addition, (3) a state where in the case where the biostimulant is applied to provide the tolerant of plants to the high temperature stress, for safety margin, the biostimulant is applied several times, but later analysis indicates that only the final application of the biostimulant is actually necessary and the earlier applications of the biostimulant are wasted may occur. With respect to such problems, in a plastic greenhouse, previous direct application of the agricultural composition of the first aspect of the present invention to plants or previous application onto soils in which plants are grown allows the temperature-responsive substrate composing the agricultural composition of the first aspect of the present invention to start to melt or decompose and thus the biostimulant to be supplied from the agricultural composition of the first aspect of the present invention when the temperature in the plastic greenhouse becomes higher in association with the rise in temperature and thus the temperature in the plastic greenhouse reaches “the temperature at which the biostimulant is required to be supplied to plants in order to provide tolerance to the high temperature stress for plants”, that is, the predetermined temperature. Therefore, in house cultivation in summer, the biostimulant can be rapidly and timely supplied when the supply of the biostimulant is required to plants by only one time of the previous application. Therefore, for the agricultural composition of the first aspect of the present invention, efficient greenhouse cultivation in summer can be performed.

With the agricultural composition of the second aspect of the present invention, direct application of the agricultural composition of the second aspect of the present invention to plants or application onto soils where plants are grown before a predicted day when the environmental temperature reaches a temperature at which the low temperature stress is applied allows the temperature-responsive substrate composing the agricultural composition of the second aspect of the present invention to start to melt or decompose and thus the biostimulant to be supplied from the agricultural composition of the second aspect of the present invention when the environmental temperature reaches “the temperature at which the biostimulant is required to be supplied to plants in order to provide tolerance to the low temperature stress for plants”, that is, the predetermined temperature. Therefore, the biostimulant can be timely supplied when plants require the biostimulant.

When the agricultural composition of the second aspect of the present invention is directly applied to the plants or applied to soils in which the plants are grown before the day on which the environmental temperature is expected to cause the low temperature stress. Thereafter, however, contrary to the expectations, even when the environmental temperature continues to be not low enough to cause the low temperature stress to the plants for a while, the temperature-responsive substrate composing the agricultural composition of the second aspect of the present invention does not start melting or decomposing until the temperature reaches “the temperature at which the biostimulant is required to be supplied to plants in order to provide tolerance to the low temperature stress for plants”, that is, the predetermined temperature, and therefore the biostimulant is not released from the agricultural composition of the second aspect of the present invention. Consequently, the biostimulant is not wasted even when the agricultural composition of the second aspect of the preset invention is applied excessively early.

The proper growing temperature for growing beans, for example, soybeans, is around 25° C. However, it has been known that yields decrease when low temperatures continue. For example, the biostimulant is effective for the purpose of improving a yield when a sudden drop in temperature occurs during the summer and fall cultivation, but the accurate prediction of the weather is difficult. Therefore, (1) a state where it is predicted that sufficient days remain until the temperature reaches a temperature at which plants cannot tolerate the low temperature stress and thus cultivation is performed without applying the biostimulant, but, in fact, the day when the temperature reaches a temperature at which plants are subjected to the low temperature stress comes opposite to the expectation and the yields decrease due to the low temperature stress before harvest may occur. In addition, (2) a state where in the case where the biostimulant is applied to provide the tolerant of plants to the low temperature stress, for safety margin, the biostimulant is applied many times, but later analysis indicates that only the final application of the biostimulant is actually necessary and the earlier applications of the biostimulant are wasted may occur. With respect to such problems, previous direct application of the agricultural composition of the second aspect of the present invention to plants of soy beans or previous application onto soils in which plants are grown allows the temperature-responsive substrate composing the agricultural composition of the second aspect of the present invention to start to melt or decompose and thus the biostimulant to be supplied from the agricultural composition of the second aspect of the present invention when the environmental temperature becomes lower in association with the lowering in temperature and thus the environmental temperature reaches “the temperature at which the biostimulant is required to be supplied to plants in order to provide tolerance to the low temperature stress for plants”, that is, the predetermined temperature. Therefore, in soy bean cultivation, the biostimulant can be rapidly and timely supplied when the supply of the biostimulant is required to plants by only one time of the previous application. Therefore, for the agricultural composition of the second aspect of the present invention, efficient soy bean cultivation can be performed.

In lands where the temperature reaches a temperature at which the plants cannot tolerate the high temperature stress or in lands where the temperature reaches a temperature at which the plants cannot tolerate the low temperature stress, previous direct application of the agricultural composition of the first aspect of the present invention or the agricultural composition of the second aspect of the present invention to plants or previous application onto soils in which plants are grown allows the temperature-responsive substrate composing the agricultural composition of the first aspect of the present invention or the agricultural composition of the second aspect of the present invention to start to melt or decompose and thus the biostimulant to be supplied from the agricultural composition of the first aspect of the present invention or the agricultural composition of the second aspect of the present invention when temperature rises and the temperature reaches “the temperature at which the biostimulant is required to be supplied to plants in order to provide tolerance to the high temperature stress for plants” or temperature is lowered and the temperature reaches “the temperature at which the biostimulant is required to be supplied to plants in order to provide tolerance to the low temperature stress for plants”, that is, the predetermined temperature. Therefore, for the agricultural composition of the first aspect of the present invention or the agricultural composition of the second aspect of the present invention, these compositions can be previously applied to the whole lands and the biostimulant can be timely supplied when the supply of the biostimulant is required to plants, and thus even when the land area is wide or sudden weather change occurs, the biostimulant can be rapidly supplied when the supply of the biostimulant is required to plants. On the other hand, if the biostimulant is applied directly to lands where the temperatures reach a temperature at which plants cannot tolerate the high temperature stress or lands where plants cannot tolerate the low temperature stress, the biostimulant cannot be supplied to plants in time, in the case where the land areas are excessively large or in the case where sudden weather change occurs.

Examples of methods for using the agricultural composition of the present invention include a method including forming the agricultural composition of the present invention into granular products, and applying the granular agricultural composition of the present invention onto soils in which plants are grown. In the case where the granular agricultural composition of the present invention is applied onto the soils in which plants are grown, the average granule diameter of the agricultural composition of the present invention is not particularly limited and is preferably 0.001 mm to 5.0 mm and more preferably 0.01 mm to 1.0 mm from the viewpoint of easy handling.

Examples of methods for using the agricultural composition of the present invention include a method including forming the agricultural composition of the present invention, and spraying the formed the composition with applying pressure to apply the composition onto the soils where plants are grown in the form of fine solid.

Examples of methods for using the agricultural composition of the present invention include a method including dispersing the agricultural composition of the present invention in an aqueous solvent, and directly applying the resulting dispersion to plants to perform adhesion of the agricultural composition of the present invention to the surface of leaves, stems, and other parts of plants. In the case where the agricultural composition of the present invention that is dispersed in the aqueous solvent is directly applied to plants, the dispersion to be applied, that is, the agricultural aqueous dispersion of the present invention is charactered by including the agricultural composition of the present invention and dispersing the agricultural composition of the present invention in the aqueous solvent.

The agricultural composition of the present invention included in the agricultural aqueous dispersion of the present invention preferably includes 0.10% by mass to 40.0% by mass of the spreading agent, more preferably includes 0.10% by mass to 25.0% by mass of the spreading agent, and more preferably includes 1.0% by mass to 20.0% by mass of the spreading agent. Including the spreading agent within the above range in the agricultural composition of the present invention included in the agricultural aqueous dispersion of the present invention allows the agricultural composition of the present invention included therein to adhere uniformly at a moderate density on the surface of plants by directly applying the agricultural aqueous dispersion of the present invention to the plants.

The average particle diameter of the agricultural composition of the present invention included in the agricultural aqueous dispersion of the present invention is not particularly limited as long as the diameter is large enough to be dispersed in the aqueous solvent, and is preferably 0.001 mm to 5.0 mm and more preferably 0.01 mm to 1.0 mm. The average particle diameter of the agricultural composition of the present invention included in the agricultural aqueous dispersion of the present invention within the above range allows uniform application to be performed.

Examples of the aqueous solvent used in the agricultural aqueous dispersion of the present invention include water and mixture solvents of water and aqueous alcohols, Examples of the aqueous alcohols used in the aqueous solvent include methanol, ethanol, isopropanol, and glycols.

The content of the agricultural composition of the present invention in the agricultural aqueous dispersion of the present invention is not particularly limited, and is, for example, 0.05% by mass to 10.0% by mass and preferably 0.1% by mass to 1.0% by mass.

The agricultural aqueous dispersion of the present invention may include regulators, solvents, emulsifiers, preservatives, antioxidants, fragrances, dyes, pigments, stabilizers, and other compounds, if necessary.

The present invention will be specifically described with reference to Examples. The present invention, however, is not limited to Examples described below.

### EXAMPLES

Hereinafter, the compositions for agriculture of the present invention will be described with reference to Examples. The present invention, however, is not limited to the embodiments.

### Example 1

1 g of a biostimulant (zerumbone solution (0.10% by mass)) was added to 99 g of water to give a solution including the biostimulant. Subsequently, the obtained solution was heated to 60° C. 2.5% by mass of gelatin was added relative to the mass of the solution, and the resultant mixture was stirred and mixed and thereafter cooled to 0° C. Subsequently, after cooling at 0° C. for 6 hours, the solidified gel was obtained. At this time, the biostimulant content in the obtained gel was 0.001% by mass.

Subsequently, the melting start temperature of the obtained gel was measured by the following method. As a result, the melting start temperature of the obtained gel was 28° C.

Subsequently, the obtained gel was used to test for verification against a high temperature stress using the following test method. The results are listed in Table 1 and Table 2.

### <Method for Measuring Melting Start Temperature>

A test tube having a shape of 15 mm and a height of 150 mm was filled with 5 g of the target to be measured. Subsequently, the test tube containing the target to be measured was placed vertically in a hot water bath and heated to rise the temperature of the test tube. While the temperature of the test tube was being raised, the flow state of the content was checked by tilting the test tube together with visual inspection. When the test tube was tilted at 15 degrees from the vertical, the temperature at which the target to be measured became liquid and flowed toward the mouth side was defined as the melting start temperature.

### <Validation Test 1 for High Temperature Stress>.

Four 15-cm pots were prepared by filling seedling growing soil of which pH was adjusted to 6.0 to 6.5, Subsequently, a fertilizer was spread on the soil in each of the four pots, and thereafter the test target was applied to one pot, water was applied to one pot, and 0.10% by mass zerumbone solution was applied to each of the remaining two pots to prepare a test target applied pot, a water applied pot, a zerumbone applied pot 1, and a zerumbone applied pot 2.

Subsequently, water was regularly applied to these pots in an environment of 23° C. and these pots were allowed to stand for one week. Thereafter, komatsuna (Japanese mustard spinach) that had grown to a degree where the true leaves had developed was transferred to each of the four pots.

Subsequently, the four pots were transferred to an environment of 35° C. At this time, 0.10% by mass zerumbone solution was applied again to the zerumbone applied pot 2.

Subsequently, the growth state was checked after leaving the plants in an environment of 35° C. for one week. The results are listed in Table I.

### (Evaluation Criteria)

∘: Growth was observed in all samples
Δ: Some samples were confirmed to be poor growth states or to be not grown
x: No growth was observed

TABLE 1

| Test 1 | Evaluation | Soil observation |
|---|---|---|
| Example 1 | ∘ | Solid was observed, when the soil before |
| A | | transfer to the environment of 35° C. |
| | | was checked. |
| | | No solids could be observed by visual |
| | | observation, when the soil that allowed |
| | | to stand in the environment of 35° C. |
| | | for one week was checked. |
| B | x | The appearance is the same as C, D, and |
| | | A after allowed to stand for one week. |
| C | Δ | Same as above |
| D | ∘ | Same as above |

In Table 1, A refers to the test target applied pot, B refers to the water applied pot, C refers to the zerumbone applied pot 1, and D refers to the zerumbone applied pot 2.

### <Validation Test 2 for High Temperature Stress>.

Four 15-cm pots were prepared by filling seedling growing soil of which pH was adjusted to 6.0 to 6.5. Subsequently, a fertilizer was spread on the soil in each of the four pots, and thereafter the test target was applied to one pot, water was applied to one pot, and 0.10% by mass zerumbone solution was applied to each of the remaining two pots to prepare a test target applied pot, a water applied pot, a zerumbone applied pot 1, and a zerumbone applied pot 2.

After water was regularly applied to these pots in an environment of 23° C. and these pots were allowed to stand for one week, sown and germinated leaf lettuces on a sponge for seedling laid out on a seedling tray were transferred to each of the four pots.

Subsequently, the four pots were transferred to an environment of 35° C. At this time, 0.10% by mass zerumbone solution was applied again to the zerumbone applied pot 2.

Subsequently, the growth state was checked after leaving the plants in an environment of 35° C. for one week. The results are listed in Table 2.

TABLE 2

| Test 2 | Evaluation | Soil observation |
|---|---|---|
| Example 1 | ∘ | Solid was observed, when the soil before |
| A | | transfer to the environment of 35° C. |
| | | was checked. |
| | | No solids could be observed by visual |
| | | observation, when the soil that allowed |
| | | to stand in the environment of 35° C. |
| | | for one week was checked. |
| B | x | The appearance is the same as C, D, and |
| | | A after allowed to stand for one week. |
| C | Δ | Same as above |
| D | ∘ | Same as above |

In Table 2, A refers to the test target applied pot, B refers to the water applied pot. C refers to the zerumbone applied pot 1, and D refers to the zerumbone applied pot 2.

### Examples 2 to 6

Gels were obtained in the same manner as the manner in Example 1 except that addition of 2.5% by mass of gelatin relative to the mass of the solution was replaced with addition of 2.5% by mass in total of gelatin and thickening polysaccharide listed in Table 3 relative to the mass of the solution.

Subsequently, the melting start temperature of the obtained gel was measured in the same manner as the manner in Example 1. The results are listed in Table 3.

TABLE 3

| | Exam- | Exam- | Exam- | Exam- | Exam- |
|---|---|---|---|---|---|
| | ple | ple | ple | ple | ple |
| | 2 | 3 | 4 | 5 | 6 |
| Gelatin (%) | 2.50 | 2.35 | 2.20 | 2.05 | 1.90 |
| Agar (%) | 0 | 0.15 | 0.30 | 0.45 | 0.60 |
| Melting start | 28 | 33 | 44 | 51 | 69 |
| temperature (° C.) | | | | | |

From Table 3, it was confirmed that the gels in Examples 2 to 6 started melting at the melting start temperatures in Table 3. Therefore, it is presumed that the gels in Examples 2 to 6 can release the biostimulant at the predetermined temperature % when the melting start temperatures thereof are set to the predetermined temperatures.

### Example 7

100 g of palm oil (product name Carotino, manufactured by Carotino) was heated to 50° C., 0.1 g of the biostimulant (zerumbone solution (0.10% by mass)) was added, and the resultant mixture was stirred and mixed for 10 minutes and thereafter cooled to 0° C. to give a solid product. At this time, the content of the biostimulant in the obtained solid product was 0.001% by mass.

Subsequently, the melting start temperature of the obtained solid product was measured in the same manner as the manner in Example 1. As a result, the obtained solid product had a melting start temperature of 38° C.

Subsequently, the obtained solid product was used to conduct Verification Test 2 to the high temperature stress using the same test method as the test method in Example 1. The results are listed in Table 4.

TABLE 4

| Test 2 | Evaluation | Soil observation |
|---|---|---|
| Example 1 | ∘ | Solid was observed, when the soil before |
| A | | transfer to the environment of 35° C. |
| | | was checked. |
| | | No solids could be observed by visual |
| | | observation, when the soil that allowed |
| | | to stand in the environment of 35° C. |
| | | for one week was checked. |
| B | x | The appearance is the same as C, D, and |
| | | A after allowed to stand for one week. |
| C | Δ | Same as above |
| D | ∘ | Same as above |

In Table 4, A refers to the test target applied pot, 13 refers to the water applied pot. C refers to the zerumbone applied pot 1, and D refers to zerumbone applied pot 2.

1-6. (canceled)

7. An agricultural composition comprising:
a temperature-responsive substrate that starts to melt or decompose at a predetermined temperature; and
a biostimulant that alleviates a non-biological stress of plants or promotes plant growth.

8. The agricultural composition according to claim 7, wherein
the temperature-responsive substrate is a material that does not melt or decompose at a temperature lower than the predetermined temperature and starts to melt or decompose when temperature rises to reach the predetermined temperature; and
a melting start temperature or a decomposition start temperature of the temperature-responsive substrate is 30° C. to 60° C.

9. The agricultural composition according to claim 7, wherein
the temperature-responsive substrate is a material that does not melt or decompose at a temperature higher than the predetermined temperature and starts to melt or decompose when temperature lowers to reach the predetermined temperature; and
a melting start temperature or a decomposition start temperature of the temperature-responsive substrate is 0° C. to 20° C.

10. The agricultural composition according to claim 7, wherein the biostimulant is a compound that induces a heat shock protein.

11. The agricultural composition according to claim 8, wherein the biostimulant is a compound that induces a heat shock protein.

12. The agricultural composition according to claim 9, wherein the biostimulant is a compound that induces a heat shock protein.

13. The agricultural composition according to claim 7, wherein the temperature-responsive substrate is composed of a gel comprising water and a gelling agent.

14. The agricultural composition according to claim 8, wherein the temperature-responsive substrate is composed of a gel comprising water and a gelling agent.

15. The agricultural composition according to claim 9, wherein the temperature-responsive substrate is composed of a gel comprising water and a gelling agent.

16. An agricultural aqueous dispersion comprising
the agricultural composition according to claim 7, wherein
the agricultural composition is dispersed in an aqueous solvent.
